(19) United States
(12) Patent Application Publication
(10) Pub. No.: US 2016/0373910 A1
(43) Pub. Date: Dec. 22, 2016

(54) EMERGENCY DATA GATHERING AND COMMUNICATION SYSTEM AND METHODS OF USE

(71) Applicant: J. Darryl Moss, Roswell, GA (US)

(72) Inventor: J. Darryl Moss, Roswell, GA (US)

(21) Appl. No.: 15/246,718

(22) Filed: Aug. 25, 2016

Related U.S. Application Data
(63) Continuation-in-part of application No. 15/142,399, filed on Apr. 29, 2016.
(60) Provisional application No. 62/161,562, filed on May 14, 2015.
(60) Provisional application No. 62/272,022, filed on Dec. 28, 2015.

(51) Int. Cl. H04W 4/22; H04M 3/42; H04W 4/02

(52) U.S. Cl. CPC H04W 4/22; H04W 4/023; H04M 3/42178

(57) ABSTRACT

An emergency server configured to run an emergency software to facilitate data gathering during the emergency event, the emergency server further configured to provide display signals for displaying the data gathering steps during the emergency event, an emergency database configured to store data gathered during the emergency event, the emergency database further configured to time stamp the data gathered during the emergency event, a plurality of smart phones, each smart phone configured to communicate with the emergency server and run an emergency software, each smart phone further configured to capture data during the emergency event, and a communication controller for enabling communication between the emergency server and each smart phone, wherein the emergency server is configured to download the emergency software to each smart phone using communication controller, the emergency software executable by corresponding smart phone to capture data during emergency event and communicate emergency data to the emergency server.

### CROSS REFERENCE TO RELATED APPLICATIONS

To the full extent permitted by law, the present United States Non-provisional Patent Application, is a Continuation-in-Part of, and hereby claims priority to and the full benefit of, United States Non-provisional Application entitled “An Emergency Data Gathering and Communication System and Methods of Use” having assigned Ser. No. 15/142,399, filed on Apr. 29, 2016, United States Provisional Patent Application entitled “911 App and/or “E” Emergency App,” having assigned Ser. No. 62/161,562, filed on May 14, 2015, United States Provisional Patent Application entitled “Planet 911 iPhone App,” having assigned Ser. No. 62/272,022, filed on Dec. 28, 2015 incorporated herein by reference in its entirety.

### TECHNICAL FIELD

The disclosure relates generally to emergency communications and, more specifically, to activation, capture, data processing, communication, and storage of an emergency event.

### BACKGROUND

Emergency events include ambulance EMT or fire rescue responses to health related issues, such as, chest pain, broken bones, bleeding, or an unconscious person as well as police responses to assault and battery, theft, homicide and the like. Upon arrival emergency personnel assess each situation by interviewing victims and witnesses to recreate a factual understanding of the events leading up to the emergency call. Emergency personnel may gather video evidence from public or private surveillance cameras or oral communications evidence gathered by a recording of the 911 call. One disadvantage of this approach is that, typically little or no close proximity data in the form of video or audio was captured leading up to or during the event or altercation when the victim is mobile.

Moreover, healthcare and home surveillance technology has advanced to include electronic sensors, video-monitoring, remote health monitoring and equipment such as fall detectors, door and window monitors, bed alerts, pressure mats and smoke and heat alarms to improve safety. Moreover, another disadvantage of this approach is that, typically little or no close proximity data in the form of video was captured leading up to or during the event or altercation when the patient is mobile.

Furthermore, 911 call centers are equipped with landlines due to quality of service requiring 100% up time. An operator in a 911 call center is instructed to quickly inquire from the caller there location. One disadvantage of this approach is that such landlines are limited to caller ID information and are unable to receive text, global positioning system (GPS), or any other proximity information to precisely determine the location of the caller. This inability to precisely locate the caller results in a portion of the approximately 10,000 911 caller deaths each year.

Almost every US citizen carries a cell phone. We should use every available technology to make our families, friends, colleagues, campuses, schools, safer from criminals.

Therefore, it is readily apparent that there is a recognizable unmet need for an emergency data gathering and communication system and methods of use that functions to capture and transmit emergency data, including location, information leading up to or during an emergency event or altercation when the victim or patient is mobile. The system allows user's implement their smart phones, notebook, tablet, laptop etc. as a first line of defense against criminals and other during other emergency situations.

### BRIEF SUMMARY

Briefly described, in example embodiment, the present system and method overcomes the above-mentioned disadvantages, and meets the recognized need for an emergency data gathering and communication system and methods of use, including, in general, an emergency server configured to run an emergency software to facilitate data gathering during the emergency event, the emergency server further configured to provide display signals for displaying the data gathering steps during the emergency event, an emergency database configured to store data gathered during the emergency event, the emergency database further configured to time stamp the data gathered during the emergency event, a plurality of smart phones, each smart phone configured to communicate with the emergency server and run an emergency software, each smart phone further configured to capture data during the emergency event, and a communication controller for enabling communication between the emergency server and each smart phone, wherein the emergency server is configured to download the emergency software to each smart phone using the communication controller, the emergency software executable by the corresponding smart phone to capture data during the emergency event and communicate the emergency data to the emergency server, wherein each smart phone is located in proximity to the emergency event, and, thus, functions to capture close proximity data in the form of video, audio, location, and time stamp such data leading up to or during an emergency event or altercation when the victim or patient is mobile.

In an exemplary embodiment of the emergency event data gathering and communication system for a mobile user, the system including an emergency server configured to provide display signals for displaying a set of emergency steps during the emergency event, an emergency database configured to store emergency data gathered during the emergency event, the emergency database further configured to time stamp the emergency data gathered during the emergency event, a plurality of smart phones, each smart phone configured to communicate with the emergency server and run an emergency software, each smart phone further configured to capture the emergency data during the emergency event, a communication controller for enabling communication between the emergency server and the plurality of smart phones, wherein the emergency server is further configured to download the emergency software to each the smart phone using each of the smart phone to capture the emergency data during the emergency event and automatically communicate the emergency data to the emergency server.

In an exemplary embodiment of the emergency event data gathering and communication system for a mobile user, the system including an emergency server configured to provide display signals for displaying a set of emergency steps during the emergency event, an emergency database configured to store emergency data gathered during the emergency event, the emergency database further configured to time stamp the emergency data gathered during the emergency event, a plurality of smart phones, each smart phone configured to communicate with the emergency server and run an emergency software, each smart phone further configured to capture the emergency data during the emergency event, a communication controller for enabling communication between the emergency server and the plurality of smart phones, wherein the emergency server is further configured to download the emergency software to each the smart phone using the each smart phone to capture the emergency data during the emergency event and automatically communicate the emergency data to the emergency server, and an emergency computer, the emergency computer configured to communicate with the emergency server and run an emergency software, the emergency computer further configured to receive the emergency data from the emergency server.

Accordingly, a feature of the emergency data gathering and communication system and methods of use is its ability to capture real time video, audio, location, and time stamp such data leading up to or during an emergency event or altercation when the victim or patient is mobile.

Another feature of the emergency data gathering and communication system and methods of use is its ability to communicate real time video, audio, location, and time stamp such data leading up to or during an emergency event or altercation when the victim or patient is mobile to a 911 operator or system.

Still another feature of the emergency data gathering and communication system and methods of use is its ability to communicate real time video, audio, location, and time stamp such data leading up to or during an emergency event or altercation when the victim or patient is mobile relative to a selected ambulance EMT or fire rescue or police response personnel.

Yet another feature of the emergency data gathering and communication system and methods of use is the ability to capture caller ID, status, GPS coordinates, audio and video data of victim, patient, injured party, ambulance EMT or fire rescue or police response personnel, directions, ambulance EMT or fire rescue or police response personnel location and availability.

Yet another feature of the emergency data gathering and communication system and methods of use is the ability transmit caller ID, status, GPS coordinates (location), audio and video data of victim, patient, injured party, ambulance EMT or fire rescue or police response personnel, directions, ambulance EMT or fire rescue or police response personnel location and availability.

Yet another feature of the emergency data gathering and communication system and methods of use is the ability remotely and resident to smart phone store caller ID, status, GPS coordinates, audio and video data of victim, patient, injured party, ambulance EMT or fire rescue or police response personnel, directions, ambulance EMT or fire rescue or police response personnel location and availability.

Yet another feature of the emergency data gathering and communication system and methods of use is the ability retrieve caller ID, status, GPS coordinates, audio and video data of victim, patient, injured party, ambulance EMT or fire rescue or police response personnel, directions, ambulance EMT or fire rescue or police response personnel location and availability.

Yet another feature of the emergency data gathering and communication system and methods of use is the ability re-transmit caller ID, status, GPS coordinates, audio and video data of victim, patient, ambulance EMT or fire rescue or police response personnel, directions, ambulance EMT or fire rescue or police response personnel location and availability.

Yet another feature of the emergency data gathering and communication system and methods of use is its ability to transfer, connect, or enable two-way communication between a victim, patient, or injured party and ambulance EMT or fire rescue or police response personnel location and availability.

Yet another feature of the emergency data gathering and communication system and methods of use is its ability to transfer, connect, or enable two-way communication between a victim, patient, or injured party and such person's selected emergency contacts.

Yet another feature of the emergency data gathering and communication system and methods of use is its ability to activate features of the phone to warn or call for help, such as flashes or strobes the light, activate the speakers like a siren, voice commands or other alarm sound like yell for help, or other social awareness audible.

Yet another feature of the emergency data gathering and communication system and methods of use is its ability to store remotely caller ID, status, GPS coordinates, time, date, location, photos, audio and video data of victim, patient, injured party, ambulance EMT or fire rescue or police response personnel, directions, ambulance EMT or fire rescue or police response personnel location and availability for evidence purposes.

Yet another feature of the emergency data gathering and communication system and methods of use is its ability to enable triggering of different threat levels by the victim, patient, injured party and enable different appropriate system responses via person's selected emergency contacts, ambulance EMT, fire rescue, or police response personnel.

Yet another feature of the emergency data gathering and communication system and methods of use is its ability to provide level 1 (feeling unsafe notifications) and level (dial 911) emergency features.

Yet another feature of the emergency data gathering and communication system and methods of use is its ability to enable embedded location information in your emergency communications.

Yet another feature of the emergency data gathering and communication system and methods of use is its ability to enable a user to send texts & emails with their location and a brief message to their emergency contacts.

Yet another feature of the emergency data gathering and communication system and methods of use is its ability to store all communication, photos, audio & video, and location remotely on the cloud, data center or database.

Yet another feature of the emergency data gathering and communication system and methods of use is its ability to require a unique PIN or password to access emergency features, storage, and turn off the digital communication device.

Yet another feature of the emergency data gathering and communication system and methods of use is its ability to create a global social emergency awareness system.

Yet another feature of the emergency data gathering and communication system and methods of use is its ability to expedite and accurately notify emergency personnel.

Yet another feature of the emergency data gathering and communication system and methods of use is its ability to notify contacts or neighbors of potential or actual criminal behavior or communicate local emergency information such as fire, weather, terrorist, or other emergency information.

These and other features of the emergency data gathering and communication system and methods of use will become more apparent to one skilled in the art from the following Detailed Description of exemplary embodiments and Claims when read in light of the accompanying drawing Figures.

### BRIEF DESCRIPTION OF THE DRAWINGS

The present emergency data gathering and communication system and methods of use will be better understood by reading the Detailed Description of exemplary embodiments with reference to the accompanying drawing figures, in which like reference numerals denote similar structure and refer to like elements throughout, and in which:

FIG. 1 is a block diagram of a computer system of the present disclosure;

FIG. 2 is a block diagram of a communication, network, and storage system implemented by computer systems in FIG. 1;

FIG. 3 is a flow diagram of an exemplary embodiment of the emergency data gathering and communication system platform utilized by a user;

FIG. 4.1, 4.2, 4.3, 4.4, 4.5, 4.6, 4.7, 4.8, 4.9, are screen shots of an exemplary embodiment of the emergency data gathering and communication system in FIG. 3;

FIG. 5 is a flow diagram of an exemplary embodiment of the emergency data gathering and communication system platform utilized by a user to setup the application;

FIG. 6 is screen shots of an exemplary embodiment of the emergency data gathering and communication system in FIG. 5;

FIG. 7 is screen shots of an exemplary embodiment of the emergency data gathering and communication system in FIG. 5;

FIG. 8 is screen shots of an exemplary embodiment of the emergency data gathering and communication system in FIG. 5;

FIG. 9 is screen shots of an exemplary embodiment of the emergency data gathering and communication system in FIG. 5;

FIG. 10 is a flow diagram of an exemplary embodiment of the emergency data gathering and communication system platform utilized by a 911 center and police personnel;

FIG. 11 is screen shots of an exemplary embodiment of the emergency data gathering and communication system in FIG. 10;

FIG. 12 is screen shots of an exemplary embodiment of the emergency data gathering and communication system in FIG. 10; and

FIG. 13 is screen shots of an exemplary embodiment of the emergency data gathering and communication system in FIG. 10.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

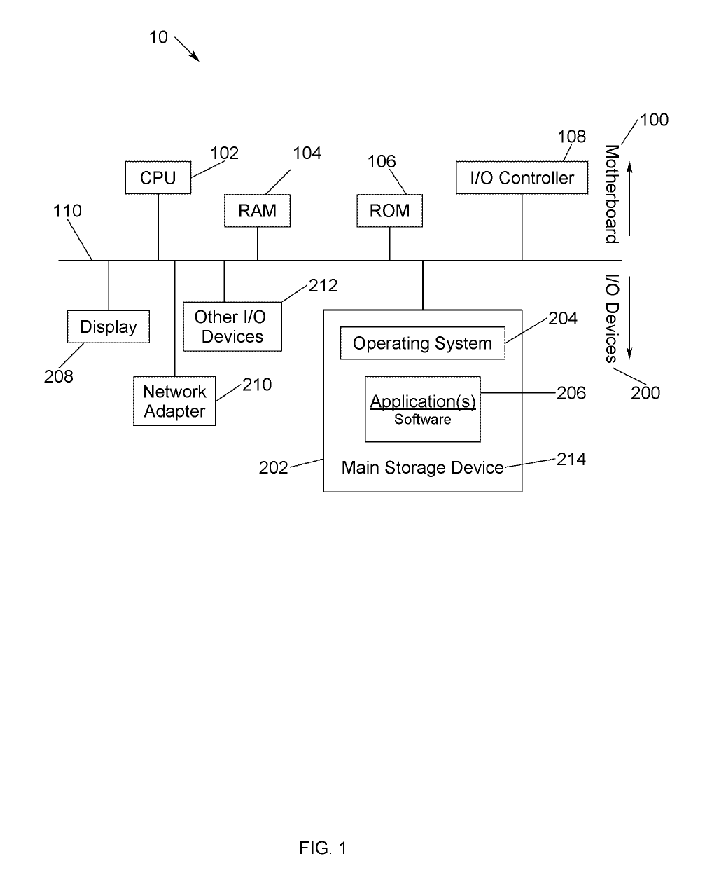

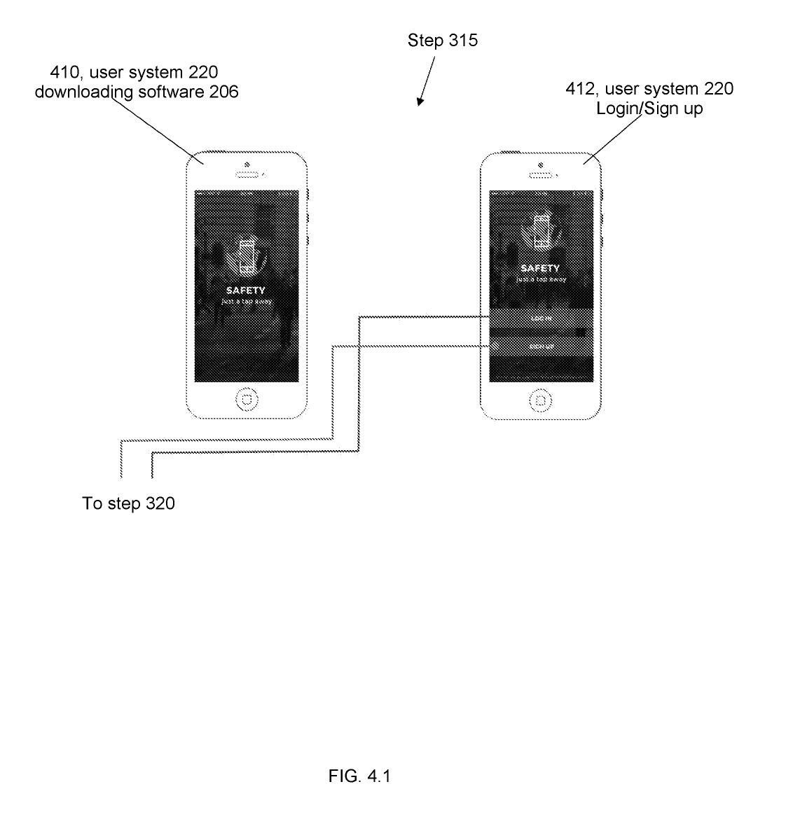

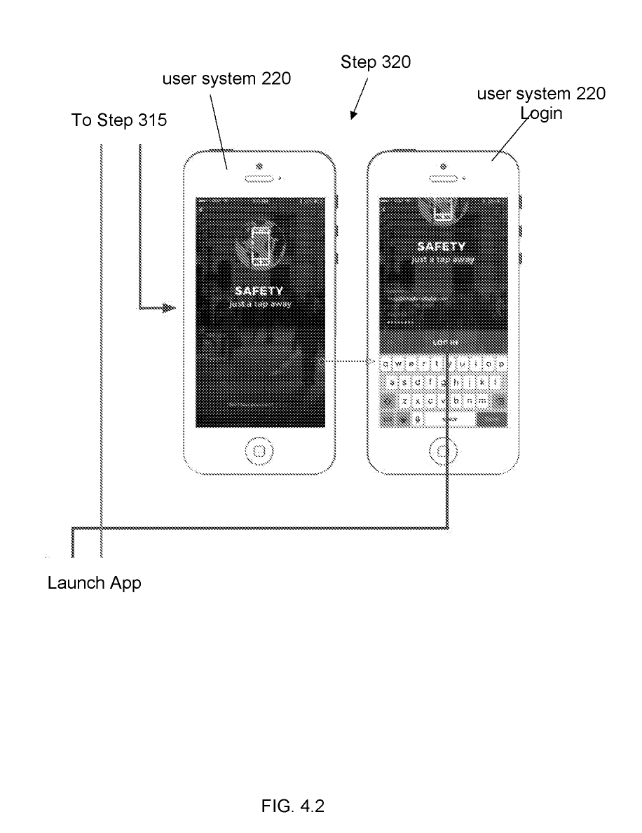

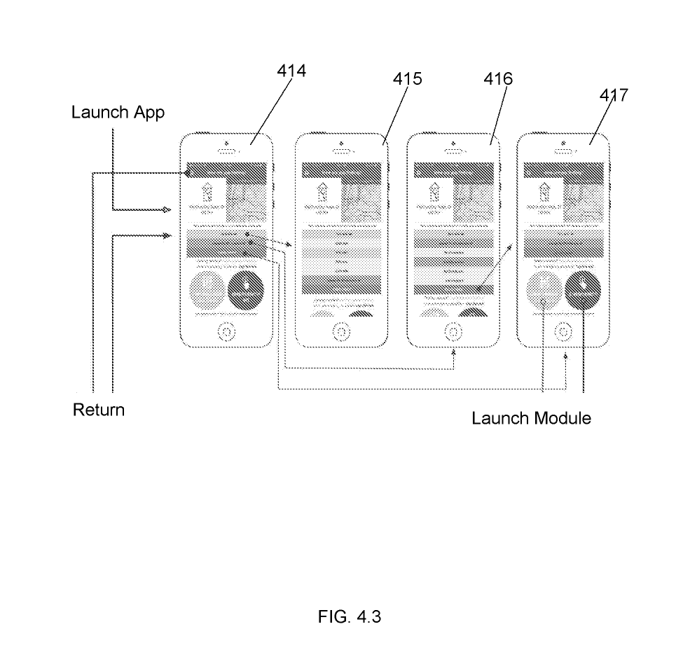

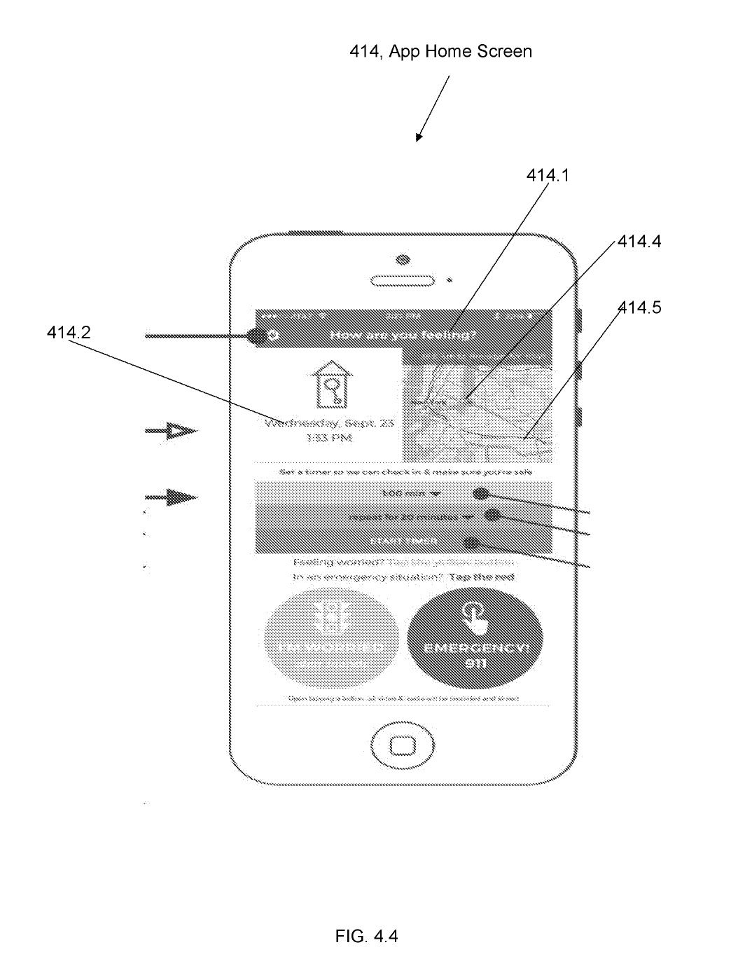

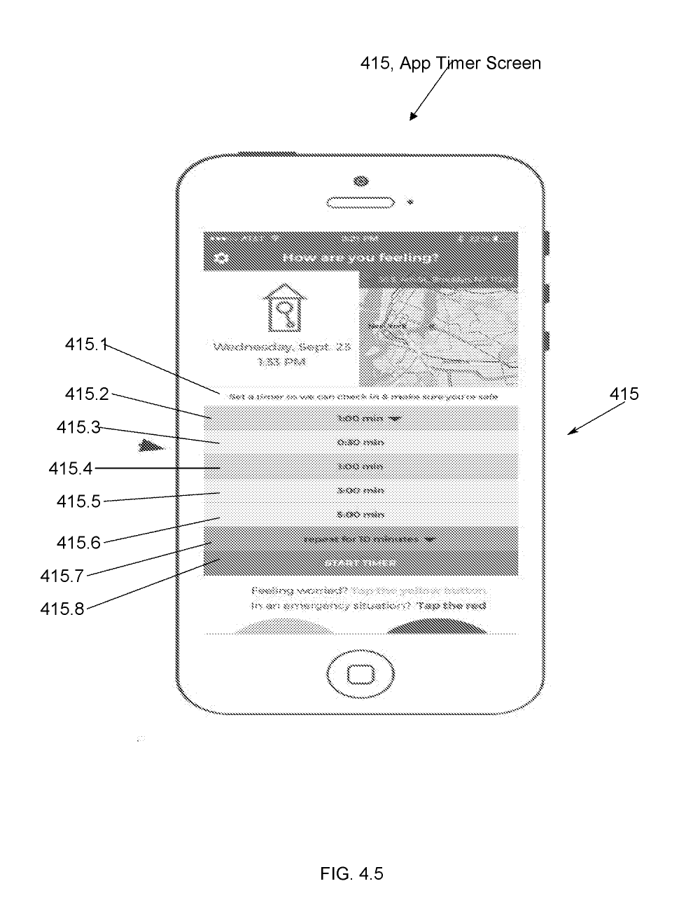

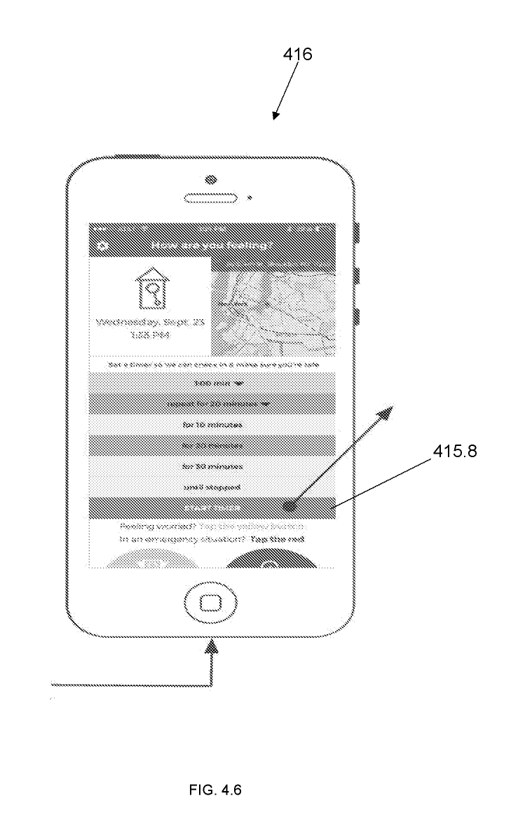

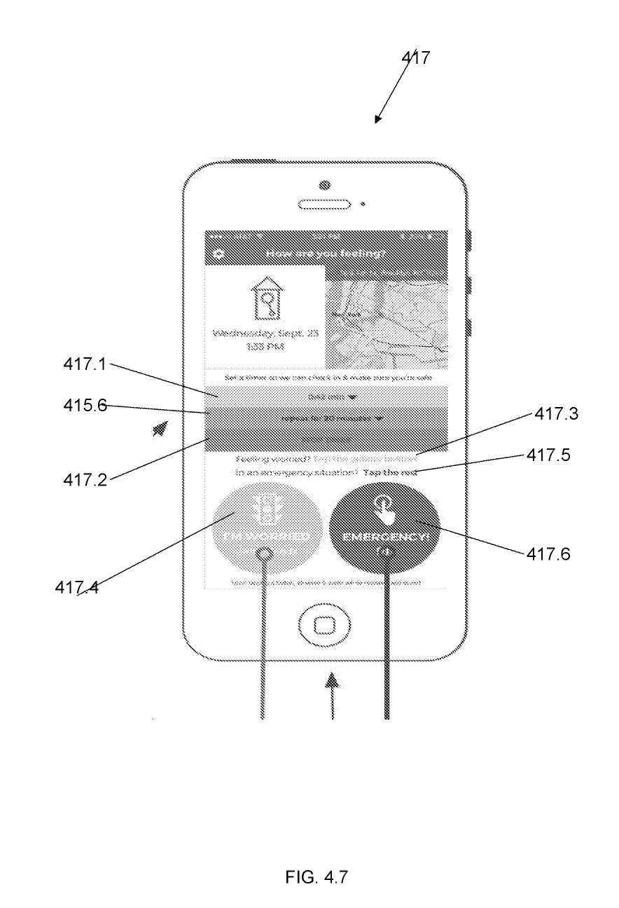

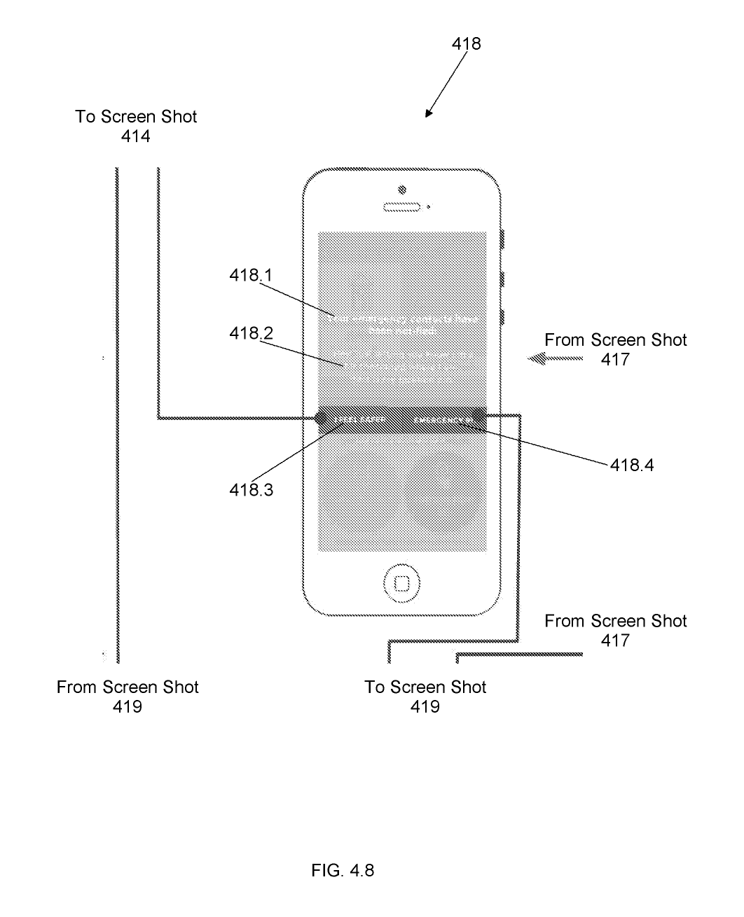

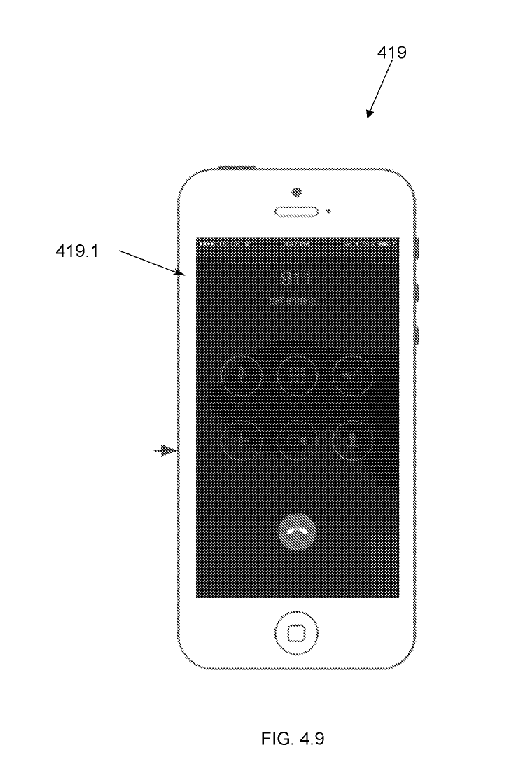

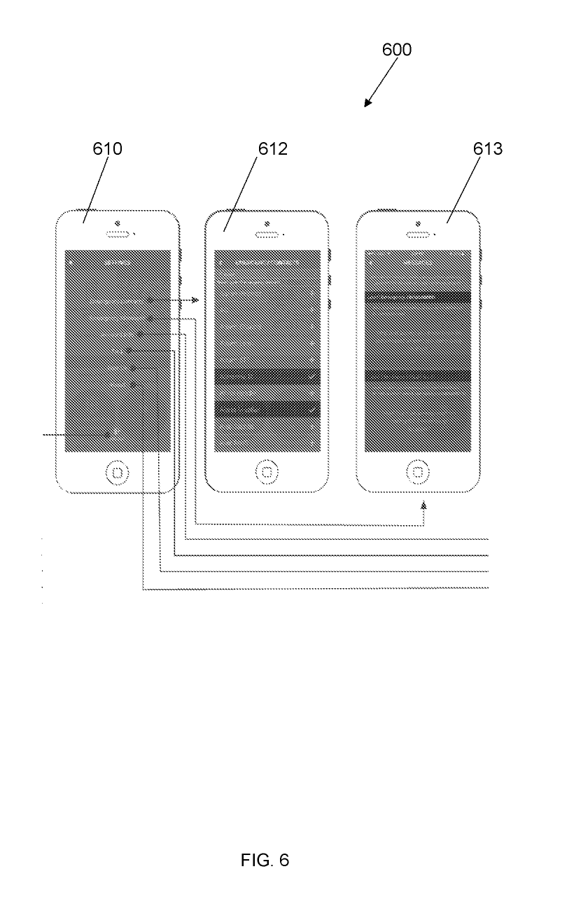

In describing the exemplary embodiments of the present disclosure, as illustrated in FIGS. 1-13, specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples, and are merely examples among other possible examples.

As will be appreciated by one of skill in the art, the present disclosure may be embodied as a method, data processing system, or computer program product. Accordingly, the present disclosure may take the form of an entirely hardware embodiment, entirely software embodiment or an embodiment combining software and hardware aspects. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These computer program instructions or operations may be loaded onto a general purpose computer, special purpose computer, or other programmable data processing apparatus to produce a machine, such that the instructions or operations, which execute on the computer or other programmable data processing apparatus, create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps.

Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations.

Computer programming for implementing the present disclosure may be written in various programming languages, database languages, and the like. However, it is understood that other source or object oriented programming languages, and other conventional programming language may be utilized without departing from the spirit and intent of the present disclosure.

Referring now to FIG. 1, there is illustrated a block diagram of a computer system 10 that provides a suitable environment for implementing embodiments of the present disclosure. The computer architecture shown in FIG. 1 is divided into two parts motherboard 100 and the input/output (I/O) devices 200. Motherboard 100 preferably includes subsystems or processor to execute instructions such as central processing unit (CPU) 102, a memory device, such as random access memory (RAM) 104, input/output (I/O) controller 108, and a memory device such as read-only memory (ROM) 106, also known as firmware, which are interconnected by bus 110. A basic input output system (BIOS) containing the basic routines that help to transfer information between elements within the subsystems of the computer is preferably stored in ROM 106, or operably disposed in RAM 104. Computer system 10 further preferably includes I/O devices 202, such as main storage device 214 for storing operating system 204 and instructions, software, module, or application program(s) 206, and display 208 for visual output, and other I/O devices 212 as appropriate. Main storage device 214 preferably is connected to CPU 102 through a main storage controller (represented as 108) connected to bus 110. Network adapter 210 allows the computer system to send and receive data through communication devices or any other network adapter capable of transmitting and receiving data over a communications link that is either a wired, optical, or wireless data pathway. It is recognized herein that central processing unit (CPU) 102 performs instructions, operations or commands stored in ROM 106 or RAM 104.

Many other devices or subsystems or other I/O devices 212 may be connected in a similar manner, including but not limited to, devices such as microphone, speakers, flash drive, CD-ROM player, DVD player, printer, main storage device 214, such as hard drive, and/or modem each connected via an I/O adapter. Also, although preferred, it is not necessary for all of the devices shown in FIG. 1 to be present to practice the present disclosure, as discussed below. Furthermore, the devices and subsystems may be interconnected in different configurations from that shown in FIG. 1, or may be based on optical or gate arrays, or some combination of these elements that is capable of responding to and executing instructions or operations. The operation of a computer system such as that shown in FIG. 1 is readily known in the art and is not discussed in further detail in this application, so as not to overcomplicate the present discussion.

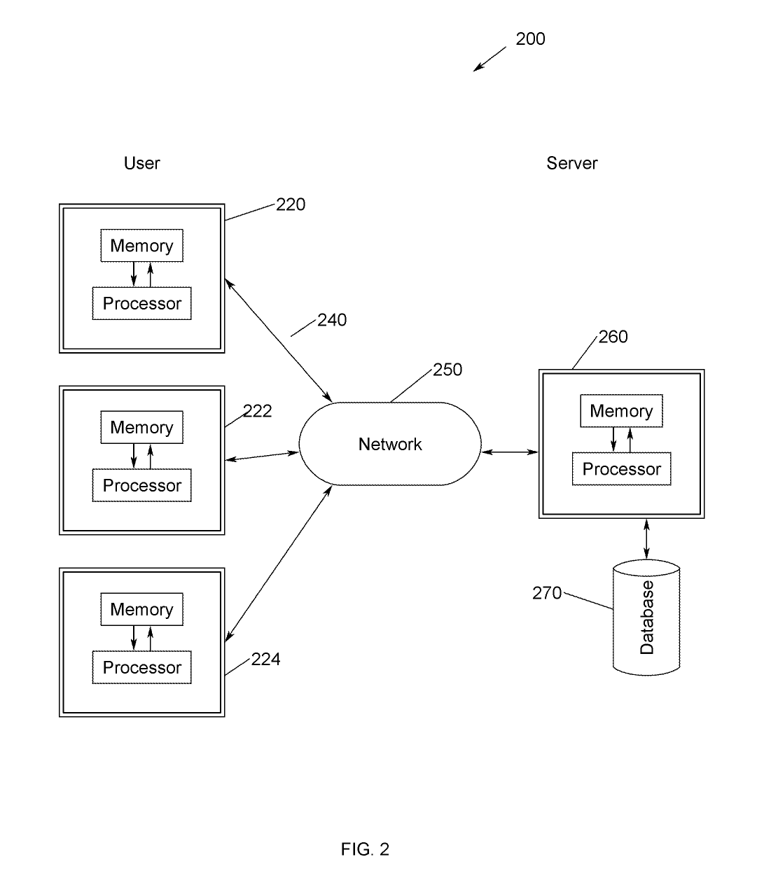

It is well known in the art that computer system 10 and/or user systems 220, 222, 224 in FIG. 2 may include a smart phone, tablet, lap top, or other portable electronic device as well as computer networking equipment, servers, routers, and equipment for data storage.

Referring now to FIG. 2, there is illustrated a diagram depicting an exemplary communication system 201 in which concepts consistent with the present disclosure may be implemented. Examples of each element within the networking and data storage system, such as communication system 201 of FIG. 2 are broadly described above with respect to FIG. 1. In particular, the server system 260 and user system 220 have attributes similar to computer system 10 of FIG. 1 and illustrate one possible implementation of computer system 10. Communication system 201 preferably includes one or more user systems 220, 222, 224, one or more server system 260, and network 250, which could be, for example, the Internet, public network, private network or cloud. User systems 220-224 each preferably include a computer-readable medium, such as random access memory, coupled to a processor. The processor, CPU 102, executes program instructions or operations stored in memory. Communication system 201 typically includes one or more user system 220. For example, user system 220, 222, 224 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a digital camera, a component, other equipment, or some combination of these elements that is capable of responding to and executing instructions or operations.

Similar to user system 220, server system 260 preferably includes a computer-readable medium, such as random access memory, coupled to a processor. The processor executes program instructions stored in memory. Server system 260 may also include a number of additional external or internal devices, such as, without limitation, a mouse, CD-ROM, keyboard or buttons, touch screen, an audio/video display, audio/video capture system, a storage device included as I/O devices 212 and other attributes similar to computer system 10 of FIG. 1. Server system 260 may additionally include a secondary storage element, data center, or cloud, such as database 270 for storage of data and information. Server system 260, although depicted as a single computer system, may be implemented as a network of computer processors. Memory in server system 260 contains one or more executable steps, program(s), algorithm(s), or application(s) 206 (shown in FIG. 1). For example, the server system 260 may include a web server, information server, application server, one or more general-purpose computers (e.g., personal computers), one or more special purpose computers (e.g., devices specifically programmed to communicate with each other, web server, database server, notification server), a workstation or other equipment, or some combination of these elements that is capable of responding to and executing instructions or operations.

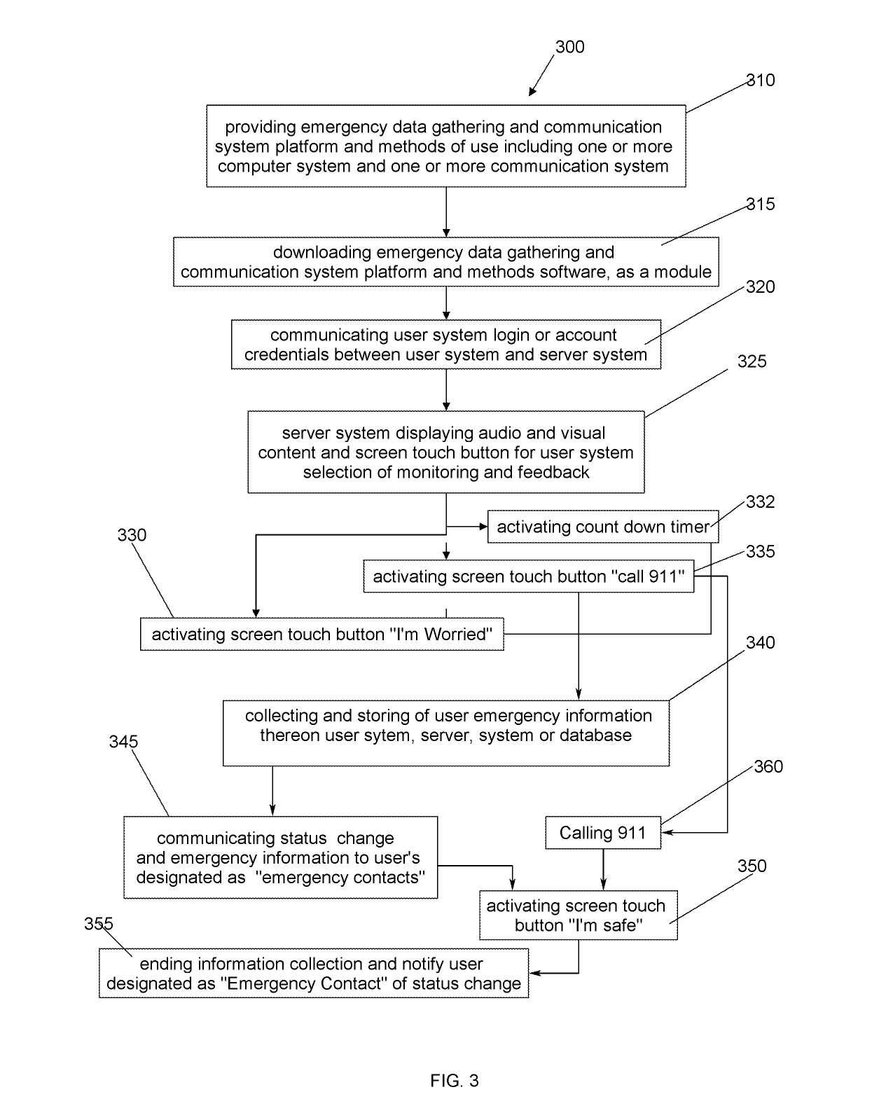

Communications system 201 is capable of delivering and exchanging data between user system 220,222, 224, and a server system 260 through one or more communications link 240 and/or network 250. Through user system 220, users can preferably communicate over network 250 with each other user system 220, 222, 224, and with other systems and devices, such as server system 260, to electronically capture, transmit, store, print and/or view or hear digital information 301 (see FIG. 3). Communications link 240 typically includes network 250 making a direct or indirect communication between the user system 220 and the server system 260, irrespective of physical separation. Examples of a network 250 include the Internet, cloud, analog or digital wired and wireless networks, radio, television, cable, satellite, and/or any other delivery mechanism for carrying and/or transmitting data or other information, such as to electronically transmit, store, print and/or view or hear digital information 303. The communications link 240 may include, for example, a wired, wireless, cable, optical or satellite communication system or other pathway.

It is contemplated herein that RAM 104, main storage device 214, and database 270 may be referred to herein as storage device(s) or memory device(s).

Referring now to FIG. 3, by way of example, and not limitation, there is illustrated a flow diagram of an exemplary embodiment of the emergency data gathering and communication system platform and methods of use 300 utilized by user 220, 222, 224 via server system 260. In block or step 310, providing emergency data gathering and communication system platform and methods of use 300 including one or more computer system 10 and one or more communication system 201. More specifically, server system 260 may include an emergency web server configured to run emergency data gathering and communication software 206 to facilitate a multi-user emergency data gathering and communication system, emergency web server further configured to provide display signals for displaying the emergency data gathering and communication software 206. Furthermore, user system 220, 222, 224 may include a display system having primary display means, the display system being configured to run emergency data gathering and communication software on the primary display means in response to the display signals and to utilize I/O devices 212 to capture audio/video, operate lights, and produce sounds. Still furthermore, server system 260 may include a communication controller configured for enabling communication between user system 220, 222, 224, and between user system 220, 222, 224 and server system 260.

In block or step 315 and screen shots 410, 412, server system 260, as emergency web server may be configured to download emergency data gathering and communication software 206, as a module, to each display, as user system 220, 222, 224 using server system 260 configured as communication controller. Each emergency data gathering and communication software module 206 executable by the corresponding display, as user system 220, 222, 224 to enable the corresponding display, as user system 220, 222, 224 to provide setup, login, use, alarm signaling, light flashing, audio/video capture, location coordinates, and like functionality on display, as user system 220, 222, 224 in response to user input received and audio/video captured by user system 220, 222, 224 which may be communicated or transmitted to server system 260, as emergency web server for storage therein database 270 of server system 260.

In block or step 320 and screen shots 410, 412, user system 220, 222, 224 may select to login or create an account communicating user system 220, 222, 224 login or account credentials there between user system 220, 222, 224 and server system 260. Login credentials may include name, address, mobile phone number, email, pin, password, emergency contacts, and emergency message and other the like information.

In block or step 325 and screen shots 414, 415, 416, server system 260 displaying audio and visual content and screen touch button for user system 220, 222, 224 selection and feedback thereto server system 260. Server system 260 may produce screen shots 414 thereon user system 220, 222, 224 that may include text displaying “How are you feeling?” 414.1, text displaying “date and time” 414.2, dynamic graphical map with pin indicator or location 414.4 of user system 220, 222, 224 indicated on the map 414.5 (auto share your location with server system 260 and specified emergency contacts).

In block or step 332 and screen shots 415, server system 260 displaying audio and visual content and screen touch button for user system 220, 222, 224 selection and feedback thereto server system 260. Server system 260 may display screen shots 415 thereon user system 220, 222, 224 that may include text displaying “Set a timer so we can check in & make sure you are safe” 415.1, drop down window 415.2 wherein user system 220 (one of the plurality smart phones) may set a timer to check in with or notify user system 222, 224 of user system 220 safety status (For example, user system 222 may be travelling between points A and B, or travelling to or from an event, (a cautioned activity or solo activity) and a typical travel time between points A and B is less than one minute), drop down window 415.2 represents selectable time increment, such as thirty seconds (0:30) 415.3, one minute (1:00) 415.4, three minute (3:00) 415.5, five minute (5:00) 415.6, drop down window 415.7 represents selectable “repeat for X minute” of time increments, such as ten minutes (10 minutes), twenty minutes (20 minutes) and the like, to repeat the sequence of selectable time increments until user system 220 cancels or indicates they “feels safe”. It is contemplated herein that if no response from user system 220 is received by server system 260 then server system 26 may proceed to step 360. Server system 260 may display in screen shot 416 and 417 timer countdown 417.1, and push touch button 415.8 to start timer countdown, and touch button 417.2 to stop timer countdown, wherein user system 220 elects to launch timer 415. Herein, user system 220 communicates selection and activation of countdown timer 415 thereto server system 260 and server system 260 displays a countdown of timer 417.1 on screen shot 417 of user system 220. Moreover in block or step 340, server system 260 stores and time stamps the information displayed thereon user system 220 as screen shots 414, 415, 416 such as text displaying “date and time” 414.2, graphic map 414.5 with location 414.4 of user system 220, 222, 224 indicated on the map 414.3, drop down window 415.2 represents selectable time increments, activation of touch button 415.8, to begin countdown of timer 415, and the like and communicates the same information thereto user system 224 (designated emergency contacts) specified in block or step 320 and communicates screen shots 410-417. In block or step 340 it is contemplated herein that server system 260 may collect emergency information or data from user system 220, 222, 224 and communicate such information to user system 224 (designated emergency contacts/one or more of the plurality smart phones) and/or user system 222, such information as, auto share your location with server system 260 and specified emergency contacts, text and email alerts, status, recorded audio/video, whether 911 called and the like.

Moreover, upon user system 220 feeling safe or unthreatened or safe status, user system 220 may push touch button 417.2 to stop countdown timer 415, wherein user system 220 elects to stop countdown timer 415. Preferably user system 220 communicates the stopping countdown timer 415 thereto server system 260, whereby server system 260 communicates such emergency information, such as user system 220 feeling safe or unthreatened or safe status stopping countdown timer 415, to user system 224 (designated emergency contacts/one or more of the plurality smart phones) and/or user system 222.

Furthermore in block or step 330, server system 260 may produce screen shots 417 thereon user system 220, 222, 224 that may include text displaying “Feeling worried? Tap the button” 417.3 or the like Level 1 and screen touch button 417.4 “I'm Worried” for user system 220 selection of status feeling worried or uncomfortable or Level 1 threat status. In use block or step 330, by activating via touching or tapping first touch screen button 417.4 “I'm Worried” (Level 1 threat status) user system 220 communicates (block or step 340) status change to server system 260, and server system 260 stores and time stamps the status change therefrom user system 220 and communicates such information (in step block or step 345) to user system 224 (designated emergency contacts) and/or user system 222, such information as, auto share your location with server system 260 and specified emergency contacts, text and email alerts to user system 224 (designated emergency contacts), status (I'm feeling afraid), user system 220 may be activated to record audio/video, whether 911 called and the like. Communication (communicates) herein may be text, email, calling, graphical or other like forms of transmitting information between server system 260 and user system 220, 222, 224. In block or step 340 it is contemplated herein that user system 220 or server system 260 may activate photo taking, burst photo taking, audio recording, and/or video recording thereon user system 220 to capture and store such emergency information or data within user system 220 and communicate such emergency information thereto server system 260 for storage in database 270. It is recognized that block or step 330 may continue until user system 220 cancels block or step 330 and verifies such action with a pin number or password or the like.

In block or step 335 and screen shots 418, thereafter user system 220 may activate by tapping second touch screen button 417.6/418.4 “Emergency” (Level 2 treat status), server system 260 may display audio and visual content and second touch screen button for user system 220, 222, 224 election and feedback thereto server system 260. In block or step 345 server system 260 may produce screen shot 418 thereon user system 220, 222, 224 that may include text displaying “Your emergency contacts have been notified” 418.1 and/or “Hey just letting you know I'm a bit concerned where I am here is my location pin” 418.2 wherein server system 260 communicated user system 220 location pin 414.6 on map 414.3 thereto user system 222 or user system 224 (designated emergency contacts).

Still furthermore in block or step 335, server system 260 may produce screen shots 417, 419 thereon user system 220, 222, 224 that may include text displaying “In an emergency situation” 417.5 or the like and screen touch button 417.6 entitled “Emergency! 911” (Level 2 treat status) or the like for user system 220 selection of status when feeling threatened, unsafe, or in an emergency situation. In use in block or step 325, by tapping second touch screen button 417.5 “Emergency” user system 220 communicates such information (in step block or step 345) to user system 224 (designated emergency contacts) and/or user system 222, such information as, auto share your location with server system 260 and specified emergency contacts, text and email alerts to user system 224 (designated emergency contacts), status (I'm feeling afraid), user system 220 may be activated to record audio/video, whether 911 called and the like. Communication (communicates) herein may be text, email, calling, graphical or other like forms of transmitting information between server system 260 and user system 220, 222, 224. In block or step 340 it is contemplated herein that user system 220 or server system 260 may activate timer, such as countdown timer 415 to time a subsequent ping or checking in with user system 220, photo taking, burst photo taking, audio recording, and/or video recording thereon user system 220 to capture and store such emergency information or data within user system 220 and communicate such emergency information thereto server system 260 for storage in database 270. Moreover, server system 260 may activate thereon user system 220 to produce a siren sound, flash the camera light, initiate call to the 911, and initiate audio/video recording. It is recognized that block or step 335 may continue until user system 220 cancels block or step 335 and verifies such action with a pin number or password or the like.

### Push Notifications

| | Update | Who Receives | Message | Opens to . . . |
|---|---|---|---|---|
| 1. | Planet911 user's | Planet911 user | “Are you safe or ae you | Button: I'm safe. |
| | timer interval ends | | in an emergency? | continue timer |
| | (but not final | | | Button: EMERGENCYI |
| | interval) | | | (commences level 2 |
| | | | | emergency & calls 9- |
| | | | | 1-1 after 5 seconds) |
| 2. | Planet911 user's | Planet911 user | “The timer has finished its | Button: Restart Timer |
| | final time interval | | last interval. We're | Button: Cancel. I'm |
| | ends (complete | | calling 9-1-1 in 5 . . . ” | safe (goes to 12.1 |
| | end of timer) | | | Home screen with |
| | | | | timer reset but not |
| | | | | started) |
| | | | | If nothing tapped |
| | | | | device calls 9-1-1 |
| | | | | after 5 seconds. |

### Text Notifications

| | Update | Who Receives | Text Message |
|---|---|---|---|
| 1. | Planet911 User taps | Emergency | “Hey! Just letting you |
| | the level 1 | contact(s) | know I'm a bit |
| | emergency button | | concerned where I am. |
| | | | Here is my location.” |
| 2. | Planet911 User taps | Emergency | “Hey! This is an |
| | the Level 2 | contact(s) | emergencyI I'm calling |
| | emergency button | | 911 and here is my |
| | | | location.” |
| 3. | Planet911 user adds | Emergency | “Hi <emergency |
| | an emergency | contact | contact name>, you've |
| | contact | | been added as an |
| | | | emergency contact for |
| | | | <Planet911 User's |
| | | | name> via the |
| | | | Planet911 app. We will |
| | | | alert you via text if the |
| | | | user feels threatened or |
| | | | is in an emergency. |
| | | | Learn more about |
| | | | Planet 911 here <link to |
| | | | app store” |
| 4. | Planet911 user taps | Emergency | “Hi <emergency |
| | ‘I FEEL SAFER” on | contact(s) | contact name>. |
| | 13.1 Level 1 | | <Planet911 user's |
| | Emergency screen | | name> is now safe.” |

In block or step 340 it is contemplated herein that user system 220 or server system 260 may activate photo taking, burst photo taking, audio recording, and/or video recording thereon user system 220 to capture and store such emergency information or data within user system 220 and communicate such emergency information thereto server system 260 for storage in database 270. Moreover, by tapping second touch screen button 417.6 user system 220 communicates status change to server system 260, and in block or step 360 server system 260 or communications controller initiates a call/calls/dials to the 911 or help or police center or like emergency personnel (or server system 260 triggers user system 220 to initiate call to the 911 or help or police center screen shot 419, 419.1 “911 call” “911 call ending”) responsible for the area or district servicing the area where user system 220 is located (on map 414.5 and pin 414.4). In block or step 345 server system 260 may communicate to user system 222 (such as 911 or help or police center or emergency personnel), such information as, user system 220 location, full contact information, photo, registered vehicle, family information, medical records, specified emergency contacts, text and email alerts, status (emergency), photos, recorded audio/video, and the like emergency data. User system 222 (such as 911 or help or police center), may further communicate to its service personnel, such information as, user system 220 location, full contact information, photo, registered vehicle, family information, medical records, criminal records, specified emergency contacts, text and email alerts, status (emergency), recorded audio/video, and the like emergency data. Moreover, server system 260, user, or user system 220 may trigger user system 220 to produce emergency broadcasts, such as flashing light, screen, and produce audible sounds or play prerecorded audio file via speaker to help warn others of a pending or current emergency and/or distract or alarm the perpetrator into halting the emergency actions.

In block or step 355 server system 260 may produce screen shot 418 thereon user system 220, 222, 224 that may include text displaying “Your emergency contacts have been notified” 418.1 and/or “Hey just letting you know I'm a bit concerned where I am here is my location pin” 418.2 wherein server system 260 communicates, delivers or sends user system 220 location pin 414.6 on map 414.3 thereto user system 222 or user system 224 (designated emergency contacts).

Moreover, in block or step 355 server system 260 may produce screen shot 418 thereon user system 220 that may include third touch screen button “I Feel Safer” wherein user system 220 may activate by tapping third touch screen button 418.3 “I Feel Safer”, wherein server system 260 may communicate user system 220 by display text, audio and visual content thereon user system 220, 222, 224 (designated emergency contacts) that user system 220 status is non threatened or “Safe”. In block or step 360 server system 260 may end or terminate emergency information gathering by user system 220 by pressing a cancel button and/or entering a pin or password or other identification system.

It is contemplated herein that user system 220, 222, 224 and server system 260 may execute any of the steps in FIG. 3.

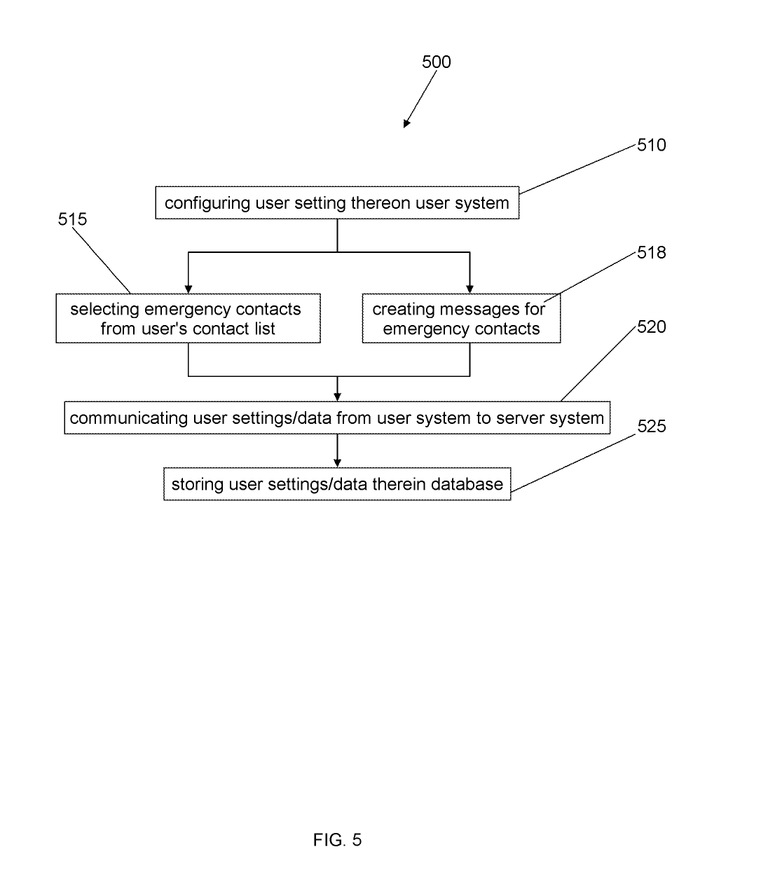

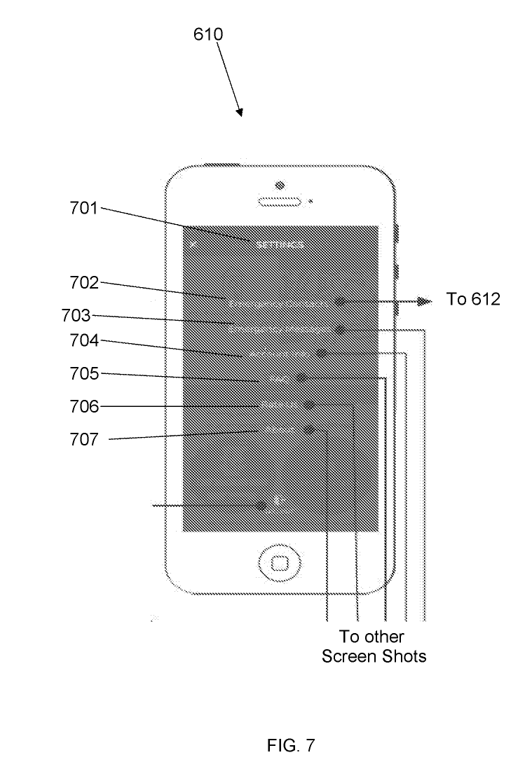

Referring now to FIG. 5, by way of example, and not limitation, there is illustrated a flow diagram of an exemplary embodiment of the emergency data gathering and communication system platform and methods of use 500 utilized by a user 220 via server system 260. In block or step 510 and screen shots 600, 610, 612, 613 server system 260 may produce screen shots 610 shown in FIG. 7, thereon user system 220, 222, 224 that may include text in screen shots, shown in FIG. 7, displaying “Settings” 701, “Emergency Contacts” 702, “Emergency Message” 703, “Account Information” 704, “FAQ” or frequently asked questions” 705, “Rate Us” 706, “About” 707, and the like.

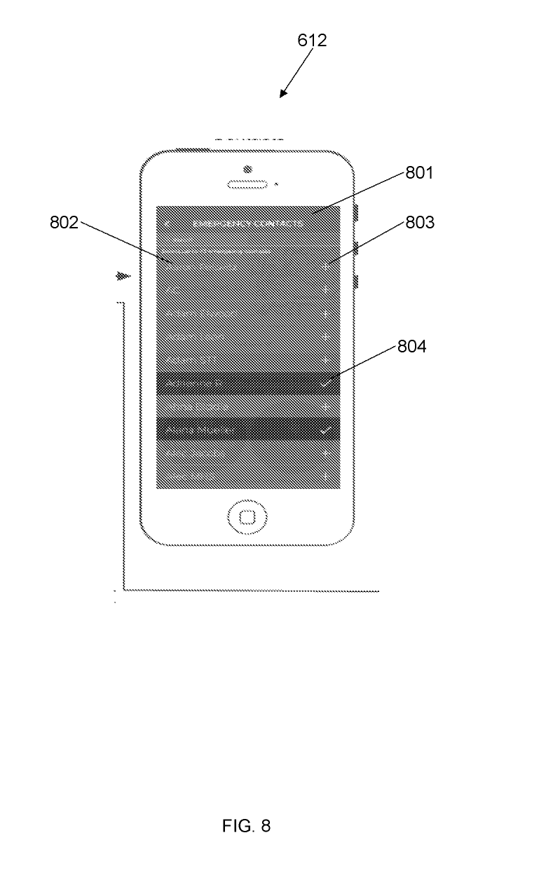

In block or step 515 and screen shots 600, 610, 612, user may select to configure, input, edit, enable access, update user information, such as “Emergency Contacts” by touching or tapping fifth touch screen button “Emergency Contacts” 702 wherein server system 260 may display screen shots 612 thereon user system 220, 222, 224. Server system 260 may produce screen shots 612, shown in FIG. 8, thereon user system 220, 222, 224 that may include text displaying “Emergency Contacts” 801 a list of contacts from user system 220, 222, 224 contact list, such as contact (1−N) 802, text displaying “+” 803 to elect to add contact 802 to user's “Emergency Contacts” 801/702 (same as user system 224 (designated emergency contacts)). If user elects to add contact 802 to user's “Emergency Contacts” 801/702 the text displaying “+” 803 may change to graphic/text displaying “√” 804.

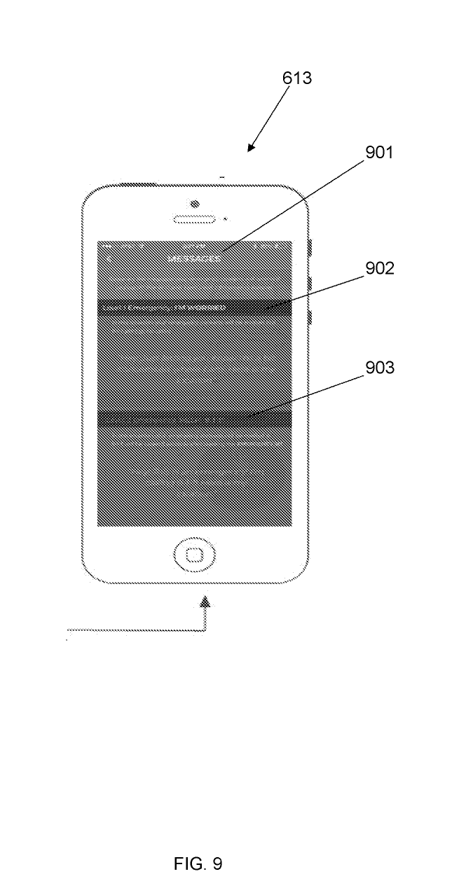

In block or step 518 and screen shots 600, 613, user may select to configure emergency messages by tapping sixth touch screen button “Emergency Messages” 703 wherein server system 260 may display screen shots 613, shown in FIG. 9, having text displaying “Message” 901 thereon user system 220, 222, 224. Server system 260 may produce screen shots 613 thereon user system 220, 222, 224 as a data entry to input emergency message as text, audio or the like, such as “Level 1 Emergency I'M WORRIED”” 902 a level 1 emergency text message. Or alternatively, server system 260 may produce screen shots 613 thereon user system 220, 222, 224 as an entry to input emergency message as text, audio or the like, such as “Level 2 Emergency HELP 911” 903 a level 2 emergency text message.

In block or step 520 and screen shots 600, 610, 612, 613, user system 224 (designated emergency contacts 801/702) (same as user system 224 (designated emergency contacts)) and/or user system 222 may communicate such information (in step block or step 345) to server system 260, such information as, auto share your location with server system 260 and specified emergency contacts 801/702, text and email alerts, status (I'm feeling afraid), recorded audio/video, whether 911 called and the like emergency data. Alternatively, user system 224 (designated emergency contacts 801/702) (same as user system 224 (designated emergency contacts)) and/or user system 222 may communicate such information (in step block or step 345) to server system 260, such information as, user system 220 location, full contact information, photo, registered vehicle, family information, medical records, specified emergency contacts, text and email alerts, status (emergency), recorded audio/video, and the like emergency data. Moreover, in block or step 525 and screen shots 600, 610, 612 server system 260 may store such information herein steps 500 or 300 in database 270.

It is contemplated herein that user system 220, 222, 224 and server system 260 may execute any of the steps in FIG. 5.

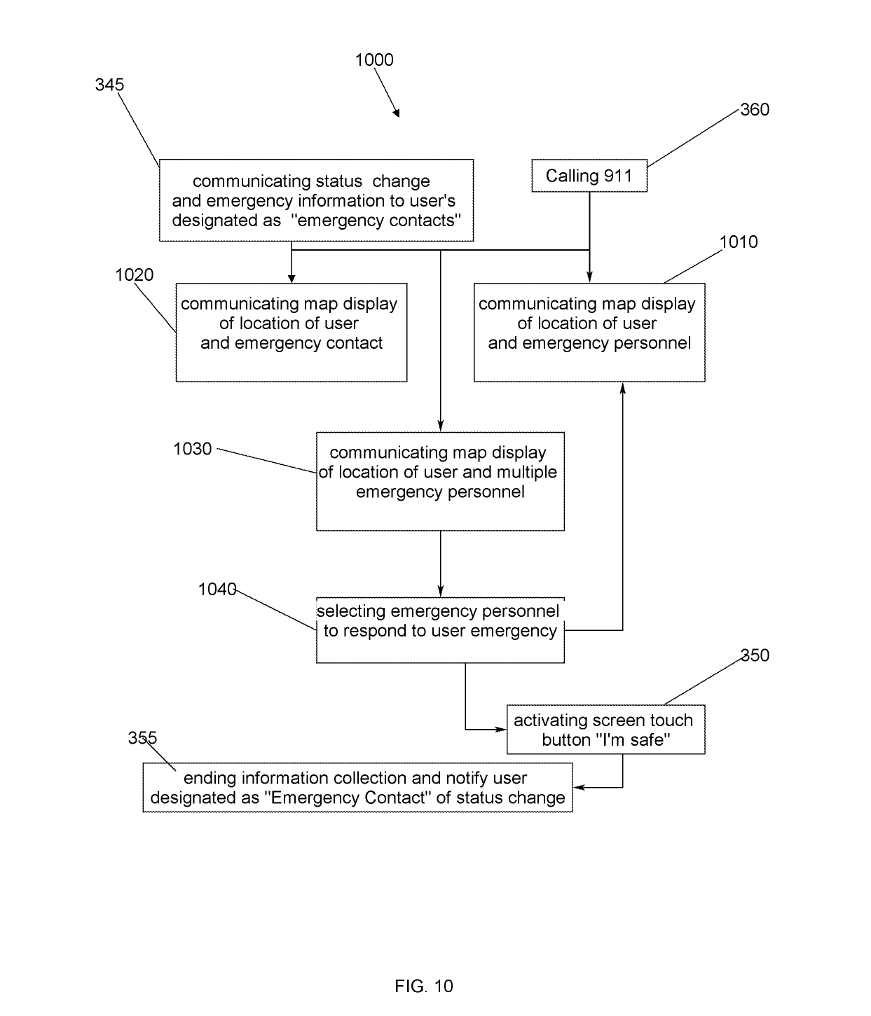

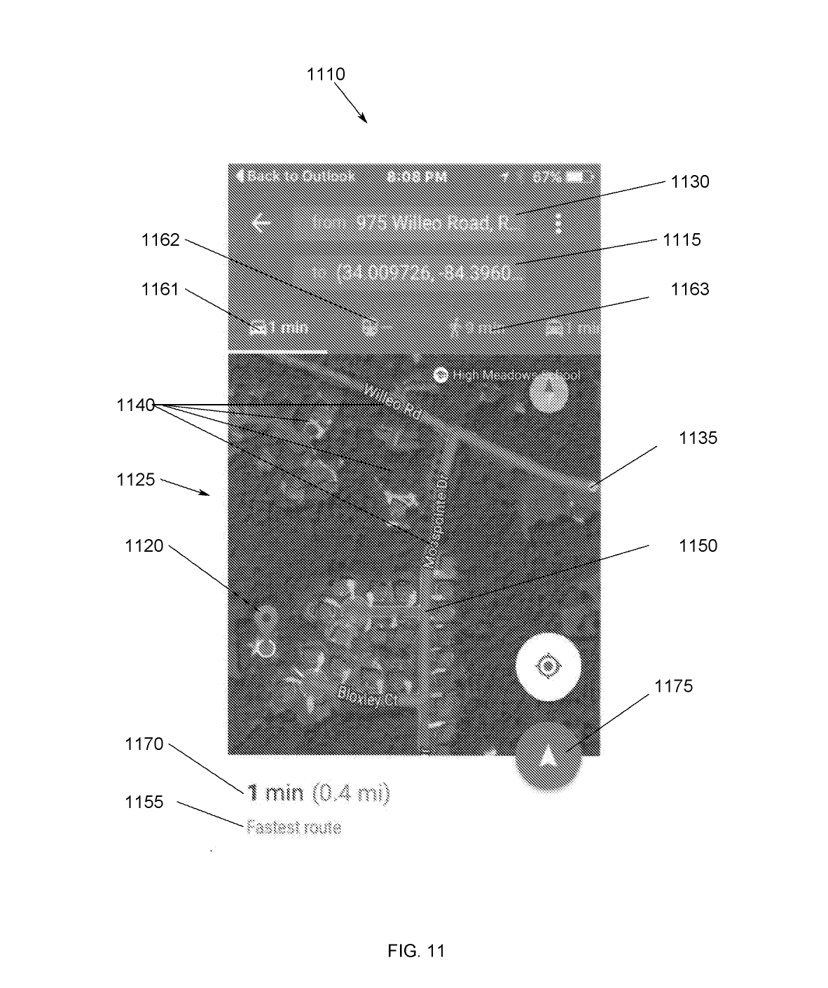

Referring now to FIG. 10, by way of example, and not limitation, there is illustrated a flow diagram of an exemplary embodiment of the emergency data gathering and communication system platform and methods of use 1000 utilized by a user 220 via server system 260, wherein user system 224 (designated emergency personnel). In block or step 360 server system 260 or communications controller initiates a call/calls/dials to the 911 or help or police center or like emergency personnel (or server system 260 triggers user system 220 to initiate call to the 911 or help or police center screen shot 419, 419.1 “911 call” “911 call ending”) responsible for the area or district servicing the area where user system 220 is located (on map 414.5 and pin 414.4) then emergency data gathering and communication system platform and methods of use 1000 may proceed to block or step 1010. In block or step 1010 and screen shot 1110 shown in FIG. 11 server system 260 may produce, communicate, deliver or send screen shots 1110 representing a location map thereon/to user system 220, 222, 224 with user 222 location in latitude and longitude coordinates or address, such as user 222 location 1115 (victim location), and further indicated as user 222 indicator, such as user 222 location pin 1120 (victim location) on user 222 location map 1125 (having terrain, structures, and street information 1140 or the like), and user 224 (designated emergency personnel) location in latitude and longitude coordinates or address, such as user 224 location 1130 (emergency personnel), and further indicated as user 224 indicator, such as user 224 location dot 1135 (emergency personnel) on user 224 location map 1125 (display map). Moreover, server system 260 may produce, communicate, deliver or send screen shots 1110 having route indicator and/or alternate route indicator, such as coded route 1150 and selected route, such as faster route 1155 between user 224 location 1130 (emergency personnel) and user 222 location 1115 (victim location). Furthermore, server system 260 may produce, communicate, deliver or send screen shots 1110 having transportation options to traverse selected route, such as faster route 1155, whether via automobile 1161, public transportation 1162, pedestrian travel, such as walking 1163, and travel duration, such as travel time/distance 1170, wherein server system 260 may produce, communicate, deliver or send screen shots 1110 with update travel time/distance 1170 of user 224, user 224 location dot 1135 on user 224 location map 1125 and/or user 222 location dot 1115 on user 222 location map 1125 as user 224 (designated emergency personnel) traverses toward user 222. User 224 (designated emergency personnel) may tap touch screen button with an icon of an arrow or other icon, wherein user system 220 may activate by tapping fifth touch screen button 1175 “icon of an arrow”, wherein server system 260 may communicate to user system 220 224 (designated emergency personnel) update travel time/distance 1170 of user 224, user 224 location dot 1135 on user 224 location map 1125 and/or user 222 location dot 1115 on user 222 location map 1125 as user 224 (designated emergency personnel) traverses toward user 222.

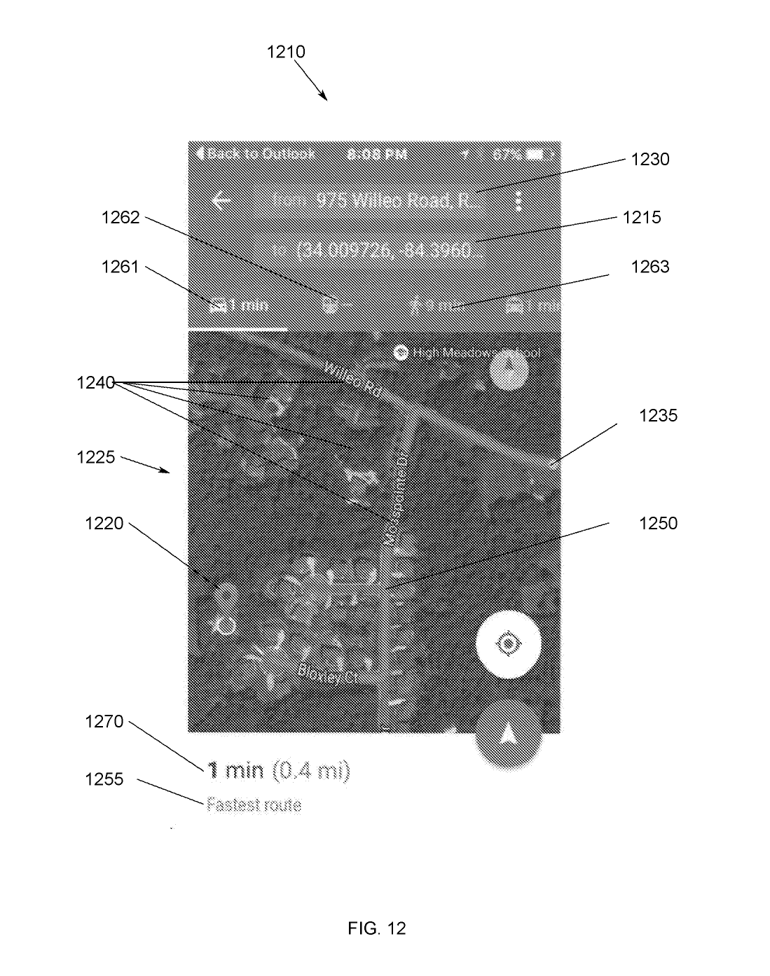

Alternatively, once block or step 360 server system 260 or communications controller initiates a call/calls/dials to the 911 or help or police center or like emergency personnel (or server system 260 triggers user system 220 to initiate call to the 911 or help or police center screen shot 419, 419.1 “911 call” “911 call ending”) responsible for the area or district servicing the area where user system 220 is located (on map 414.5 and pin 414.4) then emergency data gathering and communication system platform and methods of use 1000 may proceed to block or step 1020. In block or step 1020 and screen shot 1210 shown in FIG. 12 server system 260 may produce, communicate, deliver or send screen shots 1210 representing a location map thereon/to user system 220, 222, 224 with user 222 location in latitude and longitude coordinates or address, such as user 222 location 1215 (victim location), and further indicated as user 222 indicator, such as user 222 location pin 1220 (victim location) on user 222 location map 1225 a display map, (having terrain, structures, and street information 1240 or the like), and user 224 (designated emergency contacts 801/702) location in latitude and longitude coordinates or address, such as user 224 location 1230 (emergency contact), and further indicated as user 224 indicator, such as user 224 location dot 1235 (emergency contact) location on user 224 location map 1225 (display map). Moreover, server system 260 may produce, communicate, deliver or send screen shots 1210 having route indicator and/or alternate route indicator, such as coded route 1250 and selected route, such as faster route 1255 between user 224 location 1230 (emergency contact) and user 222 location 1215 (victim location). Furthermore, server system 260 may produce, communicate, deliver or send screen shots 1120 having transportation options to traverse selected route, such as faster route 1255, whether via automobile 1261, public transportation 1262, pedestrian travel, such as walking 1263, and travel time/distance 1270, wherein server system 260 may produce, communicate, deliver or send screen shots 1020 with update travel time/distance 1270 of user 224, user 224 location dot 1235 on user 224 location map 1225 and/or user 222 location dot 1215 on user 222 location map 1225 as user 224 (designated emergency personnel) traverses toward user 222.

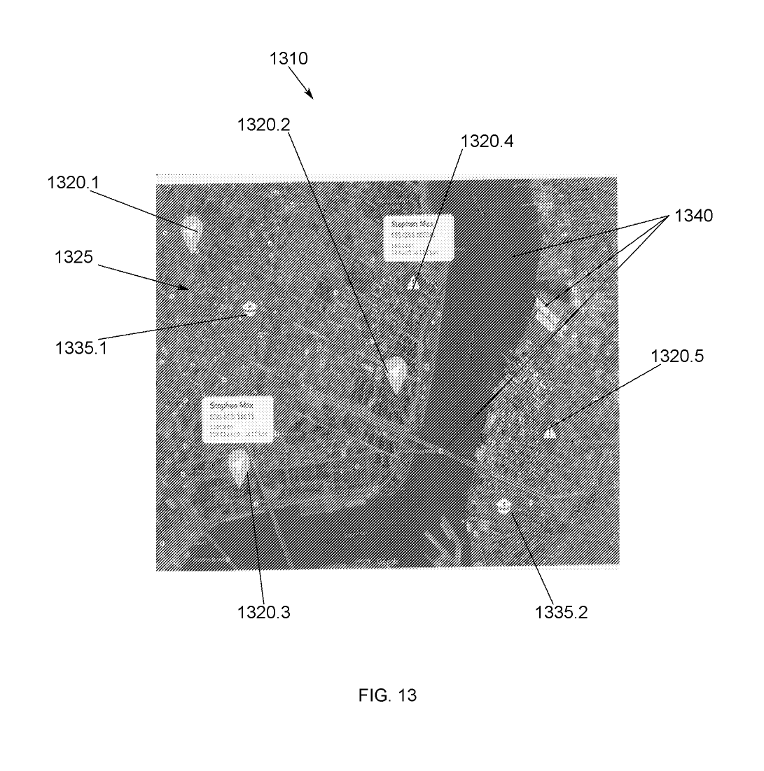

Once block or step 360 server system 260 or communications controller initiates a call/calls/dials to the 911 or help or police center or like emergency personnel (or server system 260 triggers user system 220 to initiate call to the 911 or help or police center screen shot 419, 419.1 “911 call” “911 call ending”) responsible for the area or district servicing the area where user system 220 is located (on map 414.5 and pin 414.4) then emergency data gathering and communication system platform and methods of use 1000 may proceed to block or step 1030. In block or step 1030 and screen shot 1310 shown in FIG. 13 server system 260 may produce, communicate, deliver or send screen shots 1310 representing a location map thereon user system 220, 222, 224 with user 222 location in latitude and longitude coordinates or address, such as user 222 location and/or further indicated as user 222 indicator, such as user 222 location pin 1320 (further designated as 1320.1, 1320.2, 1320.3, 1320.4, 1320.5) on user 222 location map 1325 (having terrain, structures, and street information 1340 or the like), and user 224 (designated emergency personnel) location in latitude and longitude coordinates or address, such as user 224 location and/or further indicated as user 224 indicator, such as user 224 location dot 1335 (further as 1335.1 and 1335.2) on user 224 location map 1325. Moreover, server system 260 may produce, communicate, deliver or send screen shots 1310 providing a visual representation of user 224 indicator, such as user 224 location dot 1335 (further designated as 1335.1 and 1335.2 (designated emergency personnel) relative to user 222 indicator, such as user 222 location pin 1320 (further as 1320.1, 1320.2, 1320.3, 1320.4, 1320.5). Furthermore, server system 260 may produce, communicate, deliver or send screen shots 1310 to user 224 (designated emergency personnel dispatch or headquarters) to enable user 224 (designated emergency personnel dispatch or headquarters) to evaluate each user 224 (designated emergency personnel) proximity to each user 222 (further designated as 1320.1, 1320.2, 1320.3, 1320.4, 1320.5) to determine assignments user 224 indicator, such as user 224 location dot 1335 (further designated as 1335.1 and 1335.2 (designated emergency personnel). For example, assignment may be based on proximity of user 224 indicator, such as user 224 location dot 1335 (further designated as 1335.1 and 1335.2 (designated emergency personnel) to each user 222 (further designated as 1320.1, 1320.2, 1320.3, 1320.4, 1320.5). For example, user 224 (designated emergency personnel dispatch or headquarters) may select user 224 location dot 1335 (further designated as 1335.1) to be dispatched to assist user 222 (further designated as 1320.4) due to proximity and/or may select user 224 location dot 1335 (further designated as 1335.2) to be dispatched to assist user 222 (further designated as 1320.5) due to proximity.

Furthermore, user 222 indicator, such as user 222 location pin 1320 (further designated as 1320.1, 1320.2, 1320.3, 1320.4, 1320.5) may be classified by color or otherwise visually coded to distinguish between status (I'm feeling afraid), “Level 1 Emergency I'M WORRIED”” 902 (shown in yellow), and “Level 2 Emergency HELP 911” 903 (shown in red).

Once user 224 (designated emergency personnel) has been selected by user 224 (designated emergency personnel dispatch or headquarters) to respond to the selected user 222 (further designated as 1320.1, 1320.2, 1320.3, 1320.4, 1320.5), such as user 222 (further designated as 1320.1) then emergency data gathering and communication system platform and methods of use 1000 may proceed to block or step 1010. In block or step 1010 and screen shot 1110 server system 260 may produce, communicate, deliver or send screen shots 1110 thereon user system 220, 222, 224 with user 222 location in latitude and longitude coordinates or address, such as user 222 location 1115, and further indicated as user 222 indicator, such as user 222 location pin 1120 on user 222 location map 1125 (having terrain, structures, and street information 1140 or the like), and user 224 (designated emergency personnel) location in latitude and longitude coordinates or address, such as user 224 location 1130, and further indicated as user 224 indicator, such as user 224 location dot 1135 on user 224 location map 1125. Moreover, server system 260 may produce, communicate, deliver or send screen shots 1110 having route indicator and/or alternate route indicator, such as color coded route 1150 and selected route, such as faster route 1155. Furthermore, server system 260 may produce, communicate, deliver or send screen shots 1110 having transportation options to traverse selected route, such as faster route 1155, whether via automobile 1161, public transportation 1162, pedestrian travel, such as walking 1163, wherein server system 260 may produce, communicate, deliver or send screen shots 1110 with update travel time 1170 of user 224, user 224 location dot 1135 on user 224 location map 1125 and/or user 222 location dot 1115 on user 222 location map 1125. Still furthermore, server system 260 may communicate to user system 224 (designated emergency personnel), such information as, user system 220 location, full contact information, photo, registered vehicle, family information, medical records, specified emergency contacts, text and email alerts, status (emergency), photos, recorded audio/video captured by user system 220, and the like emergency data. User system 222 (such as 911 or help or police center), may further communicate to user system 224 (designated emergency personnel) its service personnel, such information as, user system 220 location, full contact information, photo, registered vehicle, family information, medical records, criminal records, specified emergency contacts, text and email alerts, status (emergency), recorded audio/video, and the like emergency data. Moreover, server system 260, user, or user system 220 may trigger user system 220 to produce emergency broadcasts, such as flashing light, screen, and produce audible sounds or play prerecorded audio file via speaker to help warn others of a pending or current emergency and/or distract or alarm the perpetrator into halting the emergency actions.

Moreover, server system 260, may trigger user system 224 (designated emergency personnel) to activate photo taking, burst photo taking, audio recording, and/or video recording thereon user system 224 to capture and store such emergency information or data within user system 224 and communicate such user system 224 (designated emergency personnel) emergency information thereto server system 260 for storage in database 270.

Moreover, server system 260, may trigger user system 224 (designated emergency personnel) to produce emergency broadcasts, such as flashing light, screen, and produce audible sounds or play prerecorded audio file via speaker to help warn others of a pending or current emergency and/or distract or alarm the perpetrator into halting the emergency actions.

Moreover, in block or step 355 server system 260 may produce screen shot 418 thereon user system 220 that may include third touch screen button “I Feel Safer” wherein user system 220 may activate by tapping third touch screen button 418.3 “I Feel Safer”, wherein server system 260 may communicate user system 220 by display text, audio and visual content thereon user system 220, 222, 224 (designated emergency contacts) that user system 220 status is non threatened or “Safe”. In block or step 360 server system 260 may end or terminate emergency information gathering by user system 220 by pressing a cancel button and/or entering a pin or password or other identification system.

The foregoing description and drawings comprise illustrative embodiments of the present disclosure. Having thus described exemplary embodiments, it should be noted by those of ordinary skill in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one ordinarily skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions and alterations can be made thereto without departing from the spirit and scope of the disclosure as defined by the appended claims. Accordingly, the present disclosure is not limited to the specific embodiments illustrated herein, but is limited only by the following claims.

What is claimed is:

1. An emergency event data gathering and communication system for a me user, said system comprising:
an emergency server configured to provide display signals for displaying a set of emergency steps during the emergency event;
an emergency database configured to store emergency data gathered during the emergency event, the emergency database further configured to time stamp said emergency data gathered during the emergency event;
a plurality of smart phones, each smart phone configured to communicate with the emergency server and run an emergency software, each smart phone further configured to capture said emergency data during the emergency event;
a communication controller for enabling communication between the emergency server and said plurality of smart phones, wherein said emergency server is further configured to download said emergency software to each said smart phone using said each smart phone to capture said emergency data during the emergency event and automatically communicate said emergency data to said emergency server; and
an emergency computer, said emergency computer configured to communicate with the emergency server and run an emergency software, said emergency computer further configured to receive said emergency data from said emergency server.

2. The system of claim 1, wherein said emergency data is selected from the group consisting of text, photos, burst photos, video, audio, victim location, status, time, date, user communication, emergency personnel location and combinations thereof.

3. The system of claim 2, wherein said emergency server is configured to display a location of each said plurality of smart phones thereon a display map on said emergency computer during a level 2 threat status.

4. The system of claim 3, wherein said emergency server is configured to display said location of each of said plurality of smart phones on said display map as either a victim location of at least one of said plurality of smart phones or an emergency personnel location of at least one of said plurality of smart phones.

5. The system of claim 4, wherein said emergency server is configured to display thereon said plurality smart phones a screen shot representing a coded route between said victim location of at least one of said plurality of smart phones and said emergency personnel location of at least one of said plurality of smart phones.

6. The system of claim 5, wherein said emergency server is configured to display thereon said plurality smart phones a screen shot representing said emergency personnel location traversing said coded route between said victim location of at least one of said plurality of smart phones and said emergency personnel location of at least one of said plurality of smart phones.

7. The system of claim 6, wherein said communication controller activates said one of said plurality smart phones to capture said emergency data and communicate said emergency data to said emergency server.

8. The system of claim 7, wherein said one of said plurality smart phones is designated as an emergency personnel.

9. The system of claim 6, wherein said emergency server is configured to display thereon said plurality smart phones a travel time between said emergency personnel location and said victim location.

10. The system of claim 6, wherein said emergency server is configured to display thereon said plurality of smart phones a travel distance between said emergency personnel location and said victim location.

11. The system of claim 3, wherein said emergency server is configured to display said location of each of said plurality of smart phones on said display map as either a victim location of at least one of said plurality of smart phones or an emergency contact location of at least one of said plurality of smart phones.

12. The system of claim 11, wherein said emergency server is configured to display thereon said plurality smart phones a screen shot representing a coded route between said victim location of at least one of said plurality of smart phones and said emergency contact location of at least one of said plurality of smart phones.

13. The system of claim 12, wherein said emergency server is configured to display thereon said plurality smart phones a screen shot representing said emergency contact location traversing said coded route between said victim location of at least one of said plurality of smart phones and said emergency contact location of at least one of said plurality of smart phones.

14. The system of claim 13, wherein said communication controller activates said one of said plurality smart phones to capture said emergency data and communicate said emergency data to said emergency server.

15. The system of claim 13, wherein said one of said plurality smart phones is designated as an emergency contact.

16. The system of claim 13, wherein said emergency server is configured to display thereon said plurality smart phones a travel time between said emergency personnel location and said victim location.

17. The system of claim 13, wherein said emergency server is configured to display thereon said plurality smart phones a travel distance between said emergency personnel location and said victim location.

18. The system of claim 1, wherein said emergency server is configured to display thereon said one of said plurality smart phones a screen shot having a touch screen button to communicate a safe status to said emergency server.

19. The system of claim 18, wherein said one of said plurality smart phones communicates said safe status to said emergency server.

20. The system of claim 19, wherein said emergency server receives said safe status from said one of said plurality smart phones and communicates said safe status to said plurality smart phones designated as an emergency contact.

21. The system of claim 19, wherein said emergency server receives said safe status from said one of said plurality smart phones and communicates said safe status to said plurality smart phones designated as an emergency personnel.

22. The system of claim 7, wherein said emergency server receives said emergency data from said one of said plurality smart phones and communicates said emergency data to said plurality smart phones designated as an emergency personnel.

23. The system of claim 7, wherein said emergency server stores said emergency data in a database remote from said one of said plurality smart phones.

24. The system of claim 23, wherein said emergency server communicates to said one of said plurality smart phones designated as an emergency contact that communications have been delivered to said plurality smart phones designated as an emergency personnel.
